(19) United States
(12) Patent Application Publication
(10) Pub. No.: US 2009/0325561 A1
(43) Pub. Date: Dec. 31, 2009

(54) METHOD AND SYSTEM FOR ENABLING A CONFERENCE CALL

(76) Inventors: Chuan Xu, Beijing (CN); Xiang Xu, Jiangsu (CN)

Correspondence Address: MOTOROLA INC, 600 NORTH US HIGHWAY 45, W4 - 39Q, LIBERTYVILLE, IL, 60048-5343, US

(21) Appl. No.: 12/302,606

(22) PCT Filed: May 10, 2007
(86) PCT No.: PCT/US07/68625

§ 371 Date: Apr. 30, 2009

(30) Foreign Application Priority Data
May 26, 2006 (CN) 200610087839.9

(51) Int. Cl. H04M 3/56; H04B 7/00

(52) U.S. Cl. 455/416; 455/518

(57) ABSTRACT

A method and system enables a conference call that includes a push-to-talk over cellular (PoC) call session and a non-PoC over cellular call session. The method includes establishing a PoC call session between a first communication device and a second communication device using a PoC server (step 705). A non-PoC call session is also established between the first communication device and a third communication device (step 710). Transcoded media data are then generated by transcoding and buffering media data received at the first communication device from the third communication device (step 715). Permission to transmit in the PoC call session is then received at the first communication device from the PoC server (step 725). The transcoded media data are then transmitted, from the first communication device to the push-to-talk over cellular server, for forwarding to the second communication device (step 730).

### FIELD OF THE INVENTION

The present invention relates generally to wireless communication networks, and in particular to enabling a conference call that includes a push-to-talk over cellular (PoC) call session and a non-PoC call session over a wireless communication network.

### BACKGROUND

For many decades, half duplex two way radio networks have provided reliable and convenient wireless communications in a wide variety of environments. For example, “walkie-talkie” and citizens band (CB) radio networks have enabled users to maintain direct communication channels with other users over extended periods of time. The push-to-talk (PTT) and “instant on” features of half duplex radio devices provide desirable modes of wireless communication for users such as truckers, construction and industrial site personnel, military personnel, taxi dispatchers, police and fire personnel and numerous others.

Push-to-talk over cellular (PoC) is a more recent technology that enables familiar PTT and “instant on” features of conventional half duplex radios, but using mobile communication devices operating over modern cellular telecommunications networks. Using PoC, wireless communication devices such as mobile telephones and notebook computers can therefore function as PTT half-duplex radio devices. Generally, a PoC session is established between two or more wireless communication devices by registering each device with a PoC network server. When a user keys a PTT button on one of the devices, a request for permission to speak in the PoC session is transmitted from the user's device to the PoC server using for example a session initiation protocol (SIP). If no other users are currently speaking in the PoC session, an acceptance message is transmitted back to the user's device and the user can then speak into a microphone of the device. Using standard compression/decompression (codec) techniques, the user's voice is digitized and transmitted using discrete voice data packets, such as according to real-time transport protocols (RTP) and internet protocols (IP), to the PoC server. The PoC server then transmits the voice data packets to other users of the PoC session, using for example a point to multipoint communication technique.

### SUMMARY OF THE INVENTION

According to one aspect, the present invention is a method for enabling a conference call that includes a push-to-talk over cellular (PoC) call session and a non-push-to-talk over cellular call session. The method includes establishing a push-to-talk over cellular call session between a first communication device and a second communication device using a push-to-talk over cellular server. A non-push-to-talk over cellular call session is also established between the first communication device and a third communication device. Transcoded media data are then generated by transcoding and buffering media data received at the first communication device from the third communication device. Permission to transmit in the push-to-talk over cellular call session is then received at the first communication device from the push-to-talk over cellular server. The transcoded media data are then transmitted, from the first communication device to the push-to-talk over cellular server, for forwarding to the second communication device.

Embodiments of the present invention thus enable a conference call that includes a PoC call session and a non-PoC call session. That has several advantages including allowing users of conventional telephones, which do not include PoC features, to participate in a PoC call session. Further, transcoding functions of the present invention, which transcode non-PoC media data to PoC media data, and vice versa, can be performed at individual communication devices. That can provide an efficient use of network resources, as network infrastructure such as a PoC server is not required to perform transcoding. After a conference call is established according to an embodiment of the present invention, transcoding functions can be performed almost imperceptibly to conference call participants. That enables all conference call participants to experience half-duplex, push-to-talk type communications.

### BRIEF DESCRIPTION OF THE DRAWINGS

In order that the invention may be readily understood and put into practical effect, reference will now be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a functional block diagram illustrating a first communication device according to an embodiment of the present invention.

FIG. 2 is a functional block diagram illustrating components of a transcoding and buffer management module, according to an embodiment of the present invention.

FIG. 3 is a message sequence chart illustrating interactions between various network devices that enable establishment of a conference call that includes a PoC call session and a non-PoC call session, according to an embodiment of the present invention.

FIG. 4 is a message sequence chart illustrating interactions between various network devices concerning the transmission of media data in a conference call that includes a PoC call session and a non-PoC call session, according to an embodiment of the present invention.

FIG. 5 is a message sequence chart illustrating further interactions between various network devices concerning the transmission of media data in a conference call that includes a PoC call session and a non-PoC call session, according to an embodiment of the present invention.

FIG. 6 is a message sequence chart illustrating further interactions between various network devices concerning the transmission of media data in a conference call that includes a PoC call session and a non-PoC call session, according to an embodiment of the present invention.

FIG. 7 is a general flow diagram illustrating a method, from the perspective of a first communication device, for enabling a conference call that includes a PoC call session and a non-PoC call session, according to an embodiment of the present invention.

FIG. 8 is a general flow diagram illustrating sub-steps of generating, as shown in FIG. 7, transcoded media data by transcoding and buffering media data received at the first communication device from the third communication device, according to an embodiment of the present invention.

FIG. 9 is a general flow diagram illustrating sub-steps of establishing, as shown in FIG. 7, a non-PoC call session between the first communication device and the second communication device using the PoC server, according to an embodiment of the present invention.

FIG. 10 is a general flow diagram illustrating a method, from the perspective of a first communication device, for notifying a user of a third communication device that a conference call communication channel is currently unavailable, according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a method and system for enabling a conference call that includes a push-to-talk over cellular (PoC) call session and a non-PoC call session. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

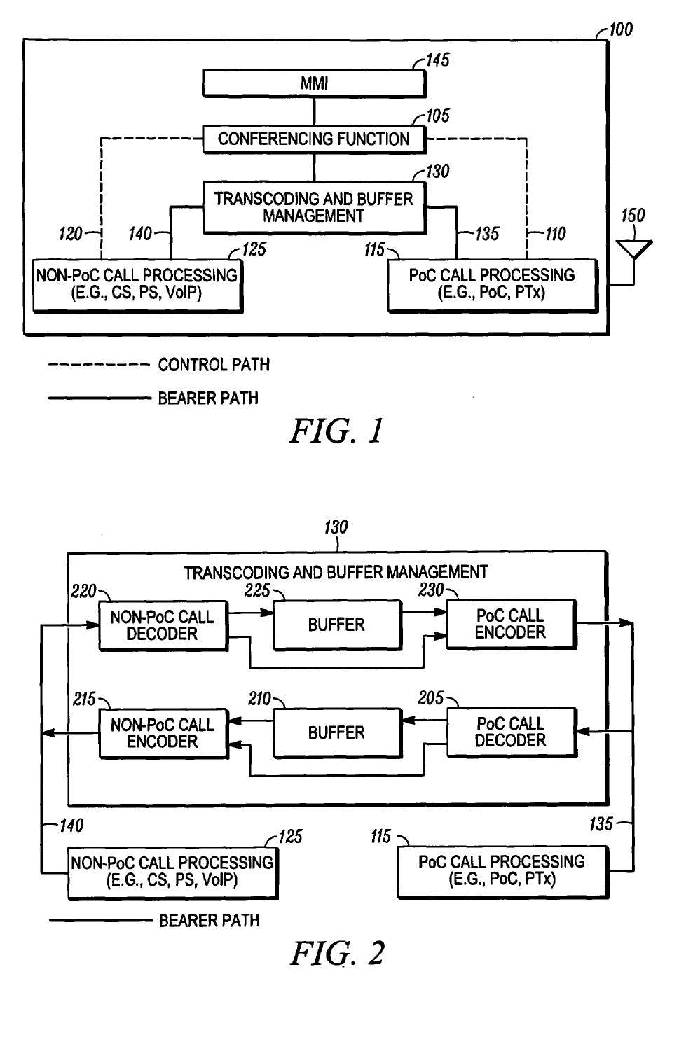

Referring to FIG. 1, a functional block diagram illustrates a first communication device 100 according to an embodiment of the present invention. A conferencing function module 105 controls conferencing calls that include a push-to-talk over cellular (PoC) call session and a non-PoC call session. A control path 110 operatively couples the conferencing function module 105 to a PoC call processing module 115, and a control path 120 operatively couples the conferencing function module 105 to a non-PoC call processing module 125. A transcoding and buffer management module 130 is operatively coupled to both the PoC call processing module 115 and to the non-PoC call processing module 125 through, respectively, a path 135 and a path 140. A man-machine interface (MMI) 145 is operatively coupled to the conferencing function module 105. An antenna 150 is used to wirelessly transmit and receive data.

Therefore, according to an embodiment of the present invention, a user of the first communication device 100 is able to participate in a conference call that requires both transmitting and receiving media data from a PoC call session, and transmitting and receiving media data from a non-PoC call session. The MMI 145 can include various types of interfaces, such as buttons, display screens, microphones, and speakers, which enable a user to transmit and receive media data concerning the conferencing functions of the present invention.

Referring to FIG. 2, a functional block diagram illustrates components of the transcoding and buffer management module 130 of the first communication device 100, according to an embodiment of the present invention. The PoC call processing module 115 processes data from various types of PoC sessions, such as voice-only PoC sessions, or multimedia sessions such as push to experience (PTx) sessions that include push-to-video and push-to-view. For purposes of the present invention, a PoC call session is therefore defined broadly to include any type of call session that enables a user to make a push-to-talk (PTT), push to video, or push to view type of connection over a packet data network. Media data as described in the present specification are therefore also defined broadly to include, for example, audio data, speech data, multimedia data, video data, text data or still image data, depending on the features, specifications or capabilities of particular embodiments of the present invention.

The non-PoC call processing module 125 processes data from various types of non-PoC call sessions, such as circuit switched (CS) call sessions, CS multimedia sessions, voice over internet protocol (VoIP) call sessions, or packet multimedia sessions over internet protocol. The transcoding and buffer management module 130 includes a PoC call decoder 205 that decodes media data from a PoC call session. Such media data can include for example encoded speech from an enhanced variable rate coder (EVRC) speech compression/decompression (codec) algorithm, an adaptive multi-rate (AMR) codec algorithm, or another type of algorithm. Decoded data from the PoC call decoder 205 are then stored in a first buffer 210. A non-PoC call encoder 215 then retrieves the data from the first buffer 210 and encodes the data in a format that can be processed by the non-PoC call processing module 125. For example, the non-PoC call encoder 215 can encode speech data in a conventional 13 kilobit per second (13K) format, or other format.

Similarly, when data moves in the other direction through the transcoding and buffer management module 130, a non-PoC call decoder 220 decodes data from a non-PoC call session and stores it in a second buffer 225. A PoC call encoder 230 then retrieves the decoded data from the second buffer 225 and encodes it in a format for use in a PoC call session.

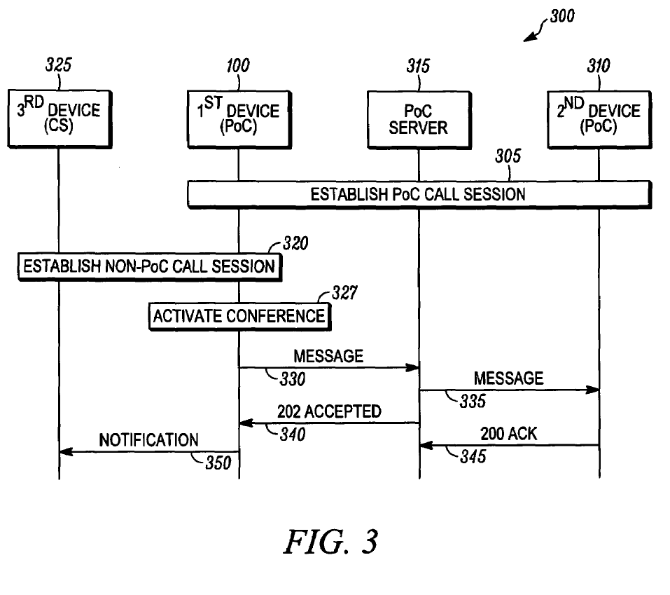

Referring to FIG. 3, a message sequence chart 300 illustrates interactions between various network devices that enable establishment of a conference call that includes a PoC call session and a non-PoC call session, according to an embodiment of the present invention. At block 305, a PoC call session is established between the first communication device 100 and a second communication device 310 using a PoC server 315. The first communication device 100 and the second communication device 310 can be devices such as mobile telephones, personal digital assistants, notebook computers or other devices that are capable of providing PoC functions. The PoC server 315 can be a network server operating from network infrastructure such as an internet protocol (IP) multimedia subsystem or, alternatively, can be implemented in other network nodes, such as in an ad hoc network, including incorporating the PoC server 315 in either the first communication device 100 or in the second communication device 310.

At block 320, a non-PoC call session is established between the first communication device 100 and a third communication device 325. For example, the third communication device 325 can be a conventional telephone that uses a circuit switched (CS) network such as a public switched telephone network (PSTN) to communicate with the first communication device 100. Alternatively, the third communication device 325 can be a device that communicates with the first communication device 100 using a voice over internet protocol (VoIP), or a wireless device that is simply not enabled to communicate directly with the PoC server 315. At block 327, a user of the first communication device 100 decides to add the third communication device 325 to a conference call that includes the first, second, and third communication devices 100, 310, 325. At line 330, the first communication device 100 transmits a message to the PoC server 315 indicating that the third communication device 325 seeks to join a conference call that includes the existing PoC call session between the first communication device 100 and the second communication device 310.

For example, the message indicated by line 330 can comprise a session initiation protocol (SIP) MESSAGE such as the following (where the first communication device 100 is identified as “User B”, the second communication device 310 is identified as “User C” and the third communication device 325 is identified as “User A”):

Request-URI sip:PoC_User C@networkX.net
SIP HEADERS
P-Preferred-Identity: “PoC User B” <sip:PoC-UserB@networkA.net>
Accept-Contact: *;+g.poc.groupad; require;explicit
User-Agent: PoC-client/OMA1.0 Acme-Talk5000/v1.01
Content-Type: application/vnd.poc.advertisement+xml
XML MIME BODY

<?xml version=“1.0” encoding=“UTF-8”?>
<group-advertisement

xmlns=“urn:oma:params:xml:ns:poc:group-advertisement”
xmlns:xsi=“http://www.w3.org/2001/XMLSchema-instance”
xsi:schemaLocation=“urn:oma:params:xml:ns:poc:groupadvert
isement”>
<note> User A has joined the conference</note>
<group type=“dialed-in”>

<display-name>Group name</display-name>
<uri>sip:OMA-Group1@networkX.net </uri>

</group>

</group-advertisement>

At line 335, the PoC server 315 transmits a message to the second communication device 310 indicating that the third communication device 325 has joined the conference call. For example, the message indicated by line 335 can comprise an SIP MESSAGE such as the following:

Request-URI sip:PoC_User C@networkX.net
SIP HEADERS
P-Preferred-Identity: “PoC User B” <sip:PoC-UserB@networkA.net>
Accept-Contact: *;+g.poc.groupad; require;explicit
User-Agent: PoC-client/OMA1.0 Acme-Talk5000/v1.01
Content-Type: application/vnd.poc.advertisement+xml
XML MIME BODY

<?xml version=“1.0” encoding=“UTF-8”?>
<group-advertisement

xmlns=“urn:oma:params:xml:ns:poc:group-advertisement”
xmlns:xsi=“http://www.w3.org/2001/XMLSchema-instance”
xsi:schemaLocation=“urn:oma:params:xml:ns:poc:groupadvert
isement”>
<note> User A has joined the conference</note>
<group type=“dialed-in”>

<display-name>Group name</display-name>
<uri>sip:OMA-Group1@networkX.net </uri>

</group>

</group-advertisement>

At line 340, the PoC server 315 then transmits an acceptance message, such as an SIP 202 ACCEPTED message, to the first communication device 100 indicating that the third communication device 325 has been accepted into the conference call. At line 345, the second communication device 310 then transmits an acknowledgement, such as an SIP 200 ACK message, back to the PoC server 315. At line 350, a notification is transmitted from the first communication device 100 to the third communication device 325. For example, such a notification may comprise an audio notification, such as a simple tone or a synthesized voice message stating “you have now been accepted into the conference call”, or another type of signal that activates an audible, tactile or visual indicator.

Those skilled in the art will appreciate that the present invention is not limited to a three-way PoC conference call. Rather, additional PoC enabled devices, similar to the first communication device 100 and the second communication device 310, also can participate in a conference call. Further, additional non-PoC devices, such as the third communication device 325, also can participate in a conference call that includes numerous PoC enabled devices. The use of three communication devices are described herein only for purposes of illustration, so as not to obscure the present disclosure with unnecessary details.

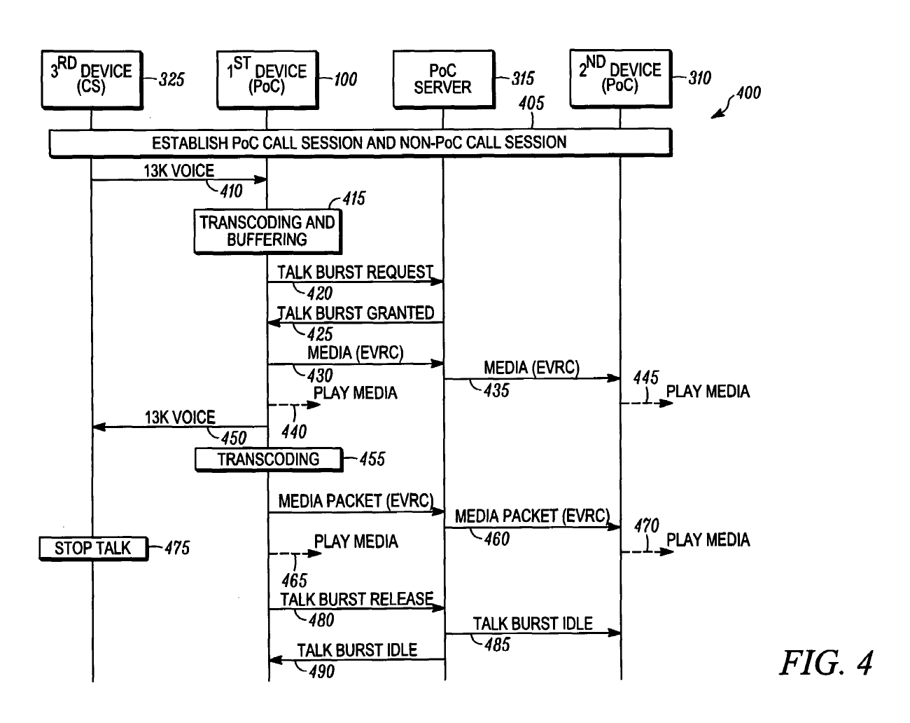

Referring to FIG. 4, a message sequence chart 400 illustrates interactions between various network devices concerning the transmission of media data in a conference call that includes a PoC call session and a non-PoC call session, according to an embodiment of the present invention. At block 405, the first communication device 100 establishes a conference call that includes a PoC call session with the second communication device 310, and a non-PoC call session with the third communication device 325. For example, such a conference call can be established according to the procedure described above regarding the message sequence chart 300. At line 410, the third communication device 325 transmits media data, such as voice data from a user who speaks into a microphone of the third communication device 325, to the first communication device 100. Because a non-PoC call session is established between the first communication device 100 and the third communication device 325, the media data are transmitted according to a conventional format such as a 13 kilobit per second (13K) format or other format.

At block 415, the first communication device 100 generates transcoded media data by transcoding and buffering the media data received from the third communication device 325. For example, the transcoded media data may be generated using the transcoding and buffer management module 130 described above.

Next, acting as a surrogate for the third communication device 325, the first communication device 100 transmits a talk burst request message to the PoC server 315. Such a talk burst request message can be any type of message that requests use of a communication channel that is managed by the PoC call session. For example, talk burst request messages can be defined according to a Talk Burst Control Protocol (TBCP), such as a TBCP defined by an Open Mobile Alliance (OMA) Technical Specification. If the channel of the PoC call session is not busy or otherwise unavailable, at line 425 the PoC server 315 transmits a talk burst granted message back to the first communication device 100. At line 430, the first communication device 100 then transmits the media data received from the third communication device 325 to the PoC server 315. For example, the media data from the third communication device 325 is retrieved from the second buffer 225, encoded by the PoC call encoder 230 and transmitted to the PoC server 315 using a PoC format. At line 435, the PoC server 315 then forwards the media data from the third communication device 325 to the second communication device 310. At line 440 and line 445, respectively, the first communication device 100 and the second communication device 310 then play the media data from the third communication device 325, using for example telephone speakers or audio headsets that are operatively coupled to the first communication device 100 and the second communication device 310.

At line 450, additional media data are transmitted from the third communication device 325 to the first communication device 100. At block 455, because the third communication device 325 already has permission to use the PoC call session based on the talk burst granted message provided at line 425, the first communication device 100 transcodes the additional media data but does not need to transmit an additional talk burst request message. The first communication device 100 then transmits the transcoded additional media data to the PoC server 315, where the data are then forwarded at line 460 to the second communication device 310. At line 465 and line 470, respectively, the first communication device 100 and the second communication device 310 then play the additional media data that were transmitted from the third communication device 325.

At block 475, the third communication device 325 does not have further media data to transmit to the other conference call participants, for example because a user of the third communication device 325 has stopped talking. Therefore, after a predetermined period of silence, at line 480 the first communication device 100 transmits a talk burst release message to the PoC server 315. The PoC server 315 then responds at line 485 and line 490, respectively, by transmitting talk burst idle messages to the second communication device 310 and to the first communication device 100. The talk burst idle messages indicate that the channel of the PoC call session is now available for use by any conference call participant.

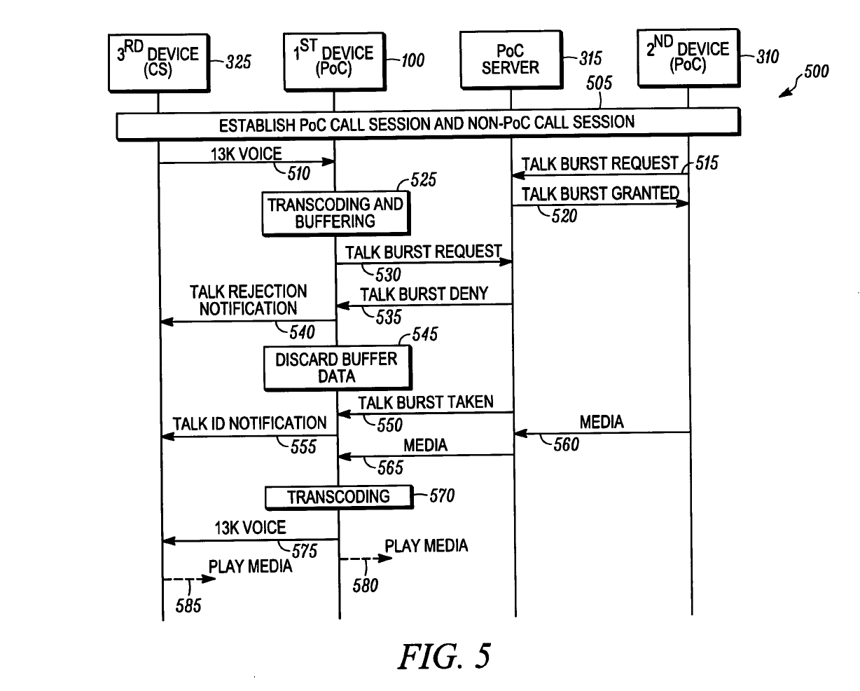

Referring to FIG. 5, a message sequence chart 500 illustrates further interactions between various network devices concerning the transmission of media data in a conference call that includes a PoC call session and a non-PoC call session, according to an embodiment of the present invention. At block 505, the first communication device 100 establishes a conference call that includes a PoC call session with the second communication device 310 and a non-PoC call session with the third communication device 325. For example, such a conference call can be established according to the procedure described above regarding the message sequence chart 300. At line 510, the third communication device 325 transmits media data, such as voice data from a user who speaks into a microphone of the third communication device 325, to the first communication device 100. Because a non-PoC call session is established between the first communication device 100 and the third communication device 325, the media data are transmitted according to conventional format such as a 13 kilobit per second (13K) format or other format.

At line 515, the second communication device 310 transmits a talk burst request message to the PoC server 315. For example, a user of the second communication device 310 may depress a PTT switch on the second communication device 310 and attempt to speak in the conference call at the same time that the user of the third communication device 325 is attempting to speak in the conference call. Because the PoC server 315 has not yet received a talk burst request message regarding the media data from the third communication device 325 that was transmitted at line 510, and because the communication channel of the conference call is therefore available, at line 520 the PoC server 315 will transmit a talk burst granted message back to the second communication device 310.

At block 525, the first communication device 100 generates transcoded media data by transcoding and buffering the media data received from the third communication device 325. For example, the transcoded media data may be generated using the transcoding and buffer management module 130 described above. Next, at line 530, the first communication device 100, acting as a surrogate for the third communication device 325, transmits a talk burst request message to the PoC server 315.

However, because a talk burst granted message was already sent at line 520 to the second communication device 310, the communication channel of the conference call is already controlled by the second communication device 310. Because of the half duplex nature of a PoC call session, the communication channel is therefore unavailable. Therefore, at line 535, the PoC server 315 transmits a talk burst deny message to the first communication device 100. At line 540, the first communication device 100 transmits a talk rejection notification message to the third communication device 325, indicating that the first communication device 100 has been denied access to the conference call. For example, such a talk rejection notification message can be in many forms including a voice synthesized message, simple audible tone, or a signal that activates an audible, tactile or visual indicator on the third communication device 325, which informs the user of the third communication device 325 that the conference call communication channel is currently unavailable.

At block 545, the data received at line 510 from the third communication device 325 are discarded by the first communication device 100. For example, data in the buffer 225 are deleted. At line 550, a talk burst taken message is also transmitted from the PoC server 315 to the first communication device 100. As will be understood by those skilled in the art, such a talk burst taken message is generally sent in conjunction with a talk burst deny message, and can be used to identify another conference call user who is currently using a conference call channel. At line 555, a talk ID notification message is therefore transmitted to the third communication device 325, which message informs the user of the third communication device 325 that the user of the second communication device 310 is currently using the conference call channel.

At line 560, media data such as PoC voice media or media data included in PTx media are then transmitted from the second communication device 310 to the PoC server 315. At line 565, the media data are then forwarded from the PoC server 315 to the first communication device 100. At block 570, the media data are then transcoded into a format that can be interpreted by the third communication device 325. Thus, for example, the media data can be decoded using the PoC call decoder 205 and then encoded using the non-PoC call encoder 215. At line 575, the transcoded media data are then transmitted from the first communication device 100 to the third communication device 325, for example as 13K voice data. Finally, at line 580, the media data are then played by the first communication device 100, using for example the MMI 145 and the data's original PoC or PTx format received from the second communication device 310. At line 585, the transcoded media data are also played by the third communication device 325.

Those skilled in the art will appreciate that, at line 580, the first communication device 100 therefore may present the media data from the second communication device 310 as video data or other multimedia data; whereas, nearly simultaneously, at line 585, the third communication device 325 may present the same media data from the second communication device 310 as simple voice data. Embodiments of the present invention thus enable devices having different capabilities and features to participate in a single conference call.

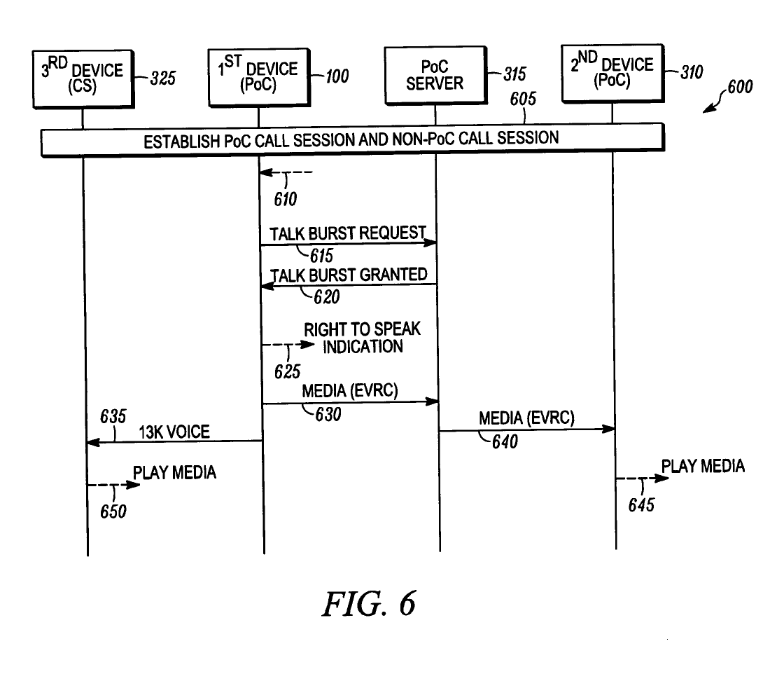

Referring to FIG. 6, a message sequence chart 600 illustrates further interactions between various network devices concerning the transmission of media data in a conference call that includes a PoC call session and a non-PoC call session, according to an embodiment of the present invention. At block 605, the first communication device 100 establishes a conference call that includes a PoC call session with the second communication device 310 and a non-PoC call session with the third communication device 325. For example, such a conference call can be established according to the procedure described above regarding the message sequence chart 300.

At line 610, a user of the first communication device 100 indicates that he or she would like to provide media data to the other participants in the conference call. The user of the first communication device 100 therefore activates the PoC function of the first communication device 100, for example by depressing a PTT button or simply by speaking into a microphone of the first communication device 100. In response, at line 615, the first communication device 100 transmits a talk burst request message to the PoC server 315. If the communication channel of the conference call is available, at line 620 the PoC server 315 will transmit a talk burst granted message back to the second communication device 310. At line 625, the first communication device 100 then provides a right to speak indication, such as an audible tone or visual signal, to the user of the first communication device 100. At line 625, the user of the first communication device 100 then begins speaking or otherwise provides media data to the first communication device 100, which data are then transmitted to the PoC server 315. Nearly simultaneously, at line 635, the first communication device 100 also transcodes to an appropriate format and transmits the media data to the third communication device 325. For example, the non-PoC call encoder 215 is used to transcode the media data to 13K voice data. At line 640, the PoC server 315 forwards the media data to the second communication device 310. Finally, at line 645, the media data are played by the second communication device 310. At line 650, the transcoded media data are also played by the third communication device 325.

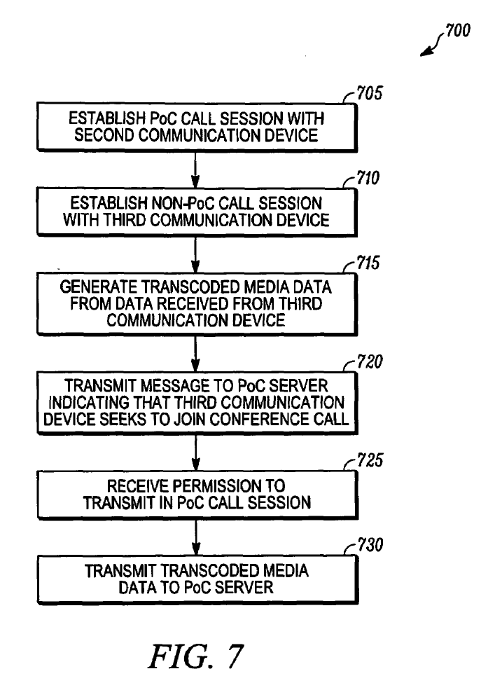

Referring to FIG. 7, a general flow diagram illustrates a method 700, from the perspective of the first communication device 100, for enabling a conference call that includes a PoC call session and a non-PoC call session, according to an embodiment of the present invention. At step 705, a PoC call session is established between the first communication device 100 and the second communication device 310 using the PoC server 315. At step 710, a non-PoC call session is established between the first communication device 100 and the third communication device 325. At step 715, transcoded media data are generated by transcoding and buffering media data received at the first communication device 100 from the third communication device 325. At step 720, a message is transmitted from the first communication device 100 to the PoC server 315 indicating that the third communication device 325 seeks to join a conference call involving the first communication device 100, the second communication device 310, and the third communication device 325. At step 725, the first communication device 100 receives permission from the PoC server 315 to transmit in the PoC call session. At step 730, the first communication device 100 transmits to the PoC server 315 transcoded voice data for forwarding to the second communication device 310.

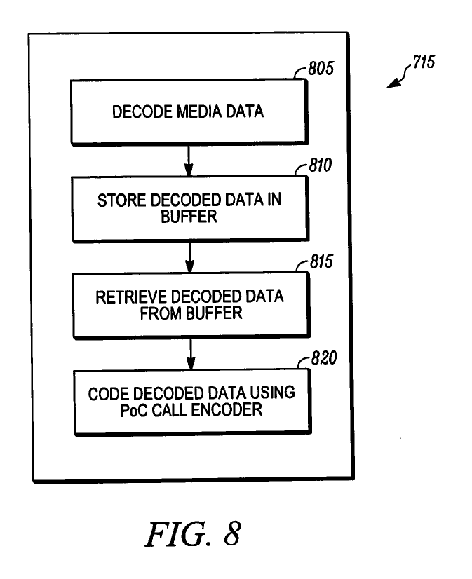

Referring to FIG. 8, a general flow diagram illustrates sub-steps of the step 715 of generating transcoded media data by transcoding and buffering media data received at the first communication device 100 from the third communication device 325, according to an embodiment of the present invention. At step 805, the media data are decoded to generate decoded data. At step 810, the decoded data are stored in the buffer 225. At step 815, the decoded data are retrieved from the buffer 225. At step 815, the decoded data are coded using the PoC call encoder 230.

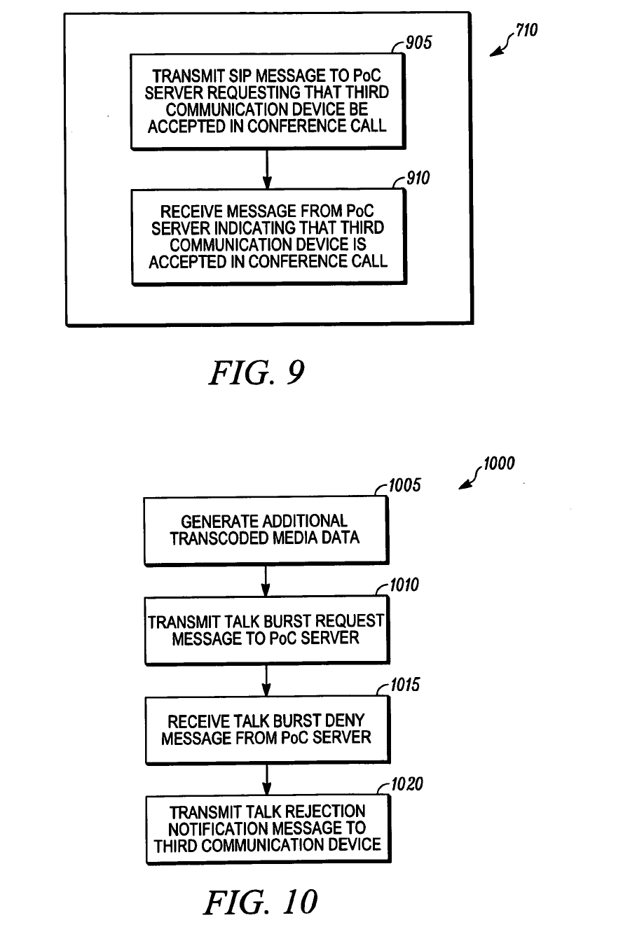

Referring to FIG. 9, a general flow diagram illustrates sub-steps of the step 710 of establishing a non-PoC call session between the first communication device 100 and the second communication device 310 using the PoC server 315, according to an embodiment of the present invention. At step 905, an SIP message is transmitted from the first communication device 100 to the PoC server 315 requesting that the third communication device 325 be accepted in a conference call involving the first communication device 100, the second communication device 310, and the third communication device 325. At step 910, a message is received at the first communication device 100 from the PoC server 315 indicating that the third communication device 325 is accepted in the conference call.

Referring to FIG. 10, a general flow diagram illustrates a method 1000, from the perspective of the first communication device 100, for notifying a user of the third communication device 325 that a conference call communication channel is currently unavailable, according to an embodiment of the present invention. Aspects of the method 1000 are further described above with reference to FIG. 5. Also, as will be understood by those skilled in the art, the method 1000 can be a continuation of the method 700 for enabling a conference call that includes a PoC call session and a non-PoC call session.

At step 1005, additional transcoded media data are generated by transcoding and buffering additional media data received at the first communication device 100 from the third communication device 325. At step 1010, a talk burst request message is transmitted from the first communication device 100 to the PoC server 315. At step 1015, a talk burst deny message is received at the first communication device 100 from the PoC server 315. Finally, at step 1020, a talk rejection notification message is transmitted from the first communication device 100 to the third communication device 325.

Those skilled in the art will recognize that the present invention can be embodied in a system such as the first communication device 100. For example, the first communication device 100 can further include a processor such as a standard microprocessor or application specific integrated circuit (ASIC) operatively coupled to a memory device. The memory device comprises a computer readable medium such as a random access memory (e.g., static random access memory (SRAM)), read only memory (e.g., programmable read only memory (PROM), or erasable programmable read only memory (EPROM)), or hybrid memory (e.g., FLASH) as are well known in the art. The medium then comprises computer readable program code components that, when processed by the processor, are configured to cause the execution of the above described steps of the methods 700 and 1000.

Embodiments of the present invention thus enable a conference call that includes a PoC call session and a non-PoC call session. That has several advantages including allowing users of conventional telephones, which do not include PoC features, to participate in a PoC call session. Further, transcoding functions of the present invention, which transcode non-PoC media data to PoC media data, and vice versa, can be performed at individual communication devices. That can provide an efficient use of network resources, as network infrastructure such as a PoC server is not required to perform transcoding. After a conference call is established according to an embodiment of the present invention, transcoding functions can be performed almost imperceptibly to the conference call participants. That enables all conference call participants to experience half-duplex, push-to-talk type communications.

It will be appreciated that embodiments of the invention described herein may be comprised of one or more conventional processors and unique stored program instructions that control the one or more processors to implement, in conjunction with certain non-processor circuits, some, most, or all of the functions of enabling a conference call that includes a PoC call session and a non-PoC call session as described herein. The non-processor circuits may include, but are not limited to, a radio receiver, a radio transmitter, signal drivers, clock circuits, power source circuits, and user input devices. As such, these functions may be interpreted as steps of a method for enabling a conference call that includes a PoC call session and a non-PoC call session. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for enabling a conference call that includes a push-to-talk over cellular call session and a non-push-to-talk over cellular call session, the method comprising:
establishing a push-to-talk over cellular call session between a first communication device and a second communication device using a push-to-talk over cellular server;
establishing a non-push-to-talk over cellular call session between the first communication device and a third communication device;
generating transcoded media data by transcoding and buffering media data received at the first communication device from the third communication device;
receiving at the first communication device permission from the push-to-talk over cellular server to transmit in the push-to-talk over cellular call session; and
transmitting, from the first communication device to the push-to-talk over cellular server, the transcoded media data for forwarding to the second communication device.

2. The method of claim 1, further comprising transmitting a message from the first communication device to the push-to-talk over cellular server indicating that the third communication device seeks to join a conference call involving the first, second, and third communication devices.

3. The method of claim 1, wherein transcoding and buffering the media data received at the first communication device from the third communication device comprises:
decoding the media data to generate decoded data;
storing the decoded data in a buffer;
retrieving the decoded data from the buffer; and
coding the decoded data using a push-to-talk over cellular call encoder.

4. The method of claim 1, wherein the media data are selected from a group comprising: audio data, speech data, multimedia data, video data, text data and still image data.

5. The method of claim 1, wherein the non-push-to-talk over cellular call session is a circuit switched call session, a circuit switched multimedia session, a voice over internet protocol call session, or a packet multimedia session over internet protocol.

6. The method of claim 1, wherein establishing the non-push-to-talk over cellular call session between the first communication device and the third communication device comprises:
transmitting, from the first communication device to the push-to-talk over cellular server, a session initiation protocol message requesting that the third communication device be accepted in a conference call involving the first, second, and third communication devices; and
receiving a message, at the first communication device from the push-to-talk over cellular server, indicating that the third communication device is accepted in the conference call.

7. The method of claim 1, wherein establishing the non-push-to-talk over cellular call session between the first communication device and the third communication device comprises receiving input from a user at a man-machine interface operatively coupled to the first communication device indicating that the user seeks to establish the conference call.

8. The method of claim 1, further comprising transmitting a notification message, from the first communication device to the third communication device, indicating that the third communication device was accepted by the push-to-talk over cellular server as a conference call participant.

9. The method of claim 1, wherein the permission from the push-to-talk over cellular server is received in response to a talk burst request message transmitted from the first communication device to the push-to-talk over cellular server.

10. The method of claim 1, further comprising:
generating additional transcoded media data by transcoding and buffering additional media data received at the first communication device from the third communication device;
transmitting, from the first communication device to the push-to-talk over cellular server, a talk burst request message;
receiving, at the first communication device from the push-to-talk over cellular server, a talk burst deny message; and
transmitting, from the first communication device to the third communication device, a talk rejection notification message.

11. A system for enabling a conference call that includes a push-to-talk over cellular call session and a non-push-to-talk over cellular call session, the system comprising:
computer readable program code components configured to cause establishment of a push-to-talk over cellular call session between a first communication device and a second communication device using a push-to-talk over cellular server;
computer readable program code components configured to cause establishment of a non-push-to-talk over cellular call session between the first communication device and a third communication device;
computer readable program code components configured to cause generation of transcoded media data by transcoding and buffering media data received at the first communication device from the third communication device;
computer readable program code components configured to cause processing at the first communication device of permission from the push-to-talk over cellular server to transmit in the push-to-talk over cellular call session; and
computer readable program code components configured to cause transmission, from the first communication device to the push-to-talk over cellular server, of the transcoded media data for forwarding to the second communication device.

12. The system of claim 11, further comprising computer readable program code components configured to cause transmission of a message from the first communication device to the push-to-talk over cellular server indicating that the third communication device seeks to join a conference call involving the first, second, and third communication devices.

13. The system of claim 11, further comprising a man-machine interface that includes a video display screen and a speaker for playing the media data.

14. The system of claim 11, further comprising a man-machine interface that includes a push-to-talk button for enabling a user to participate in the push-to-talk over cellular call session.

15. The system of claim 11, wherein the push-to-talk over cellular call session is a push to video call session.

16. The system of claim 11, wherein the non-push-to-talk over cellular call session is a circuit switched call session or a voice over internet protocol call session.

17. The system of claim 11, further comprising:
computer readable program code components configured to cause generation of additional transcoded media data by transcoding and buffering additional media data received at the first communication device from the third communication device;
computer readable program code components configured to cause transmission, from the first communication device to the push-to-talk over cellular server, of a talk burst request message;
computer readable program code components configured to cause processing, at the first communication device from the push-to-talk over cellular server, of a talk burst deny message; and
computer readable program code components configured to cause transmission, from the first communication device to the third communication device, of a talk rejection notification message.

18. A system for enabling a conference call that includes a push-to-talk over cellular call session and a non-push-to-talk over cellular call session, the system comprising:
means for establishing a push-to-talk over cellular call session between a first communication device and a second communication device using a push-to-talk over cellular server;
means for establishing a non-push-to-talk over cellular call session between the first communication device and a third communication device;
means for generating transcoded media data by transcoding and buffering media data received at the first communication device from the third communication device;
means for receiving at the first communication device permission from the push-to-talk over cellular server to talk in the push-to-talk over cellular call session; and
means for transmitting, from the first communication device to the push-to-talk over cellular server, the transcoded media data for forwarding to the second communication device.
